(19) United States
(12) Patent Application Publication
(10) Pub. No.: US 2023/0286164 A1
(43) Pub. Date: Sep. 14, 2023

(54) CONVEYANCE SYSTEM, METHOD FOR CONTROL THE SAME, AND CONTROL PROGRAM

(71) Applicant: TOYOTA JIDOSHA KABUSHIKI KAISHA, Toyota-shi (JP)

(72) Inventors: Suomi TANISHIGE, Shinagawa-ku (JP); Nobuyuki Matsuno, Edogawa-ku (JP)

(73) Assignee: TOYOTA JIDOSHA KABUSHIKI KAISHA, Toyota-shi (JP)

(21) Appl. No.: 18/171,841

(22) Filed: Feb. 21, 2023

(30) Foreign Application Priority Data
Mar. 14, 2022 (JP) 2022-039111

(51) Int. Cl. B25J 9/16; B25J 9/00; G06V 10/764; G06V 20/64

(52) U.S. Cl. CPC B25J 9/1697; B25J 9/0093; G06V 10/764; G06V 20/64; G06V 2201/06; G06V 2201/07

(57) ABSTRACT

A conveyance system includes: a first recognition device configured to identify whether or not a target object is an object of a first type; and a work robot configured to classify the target object as the object of the first type when the target object is identified as the object of the first type by the first recognition device and to classify the target object as an object of a type corresponding to position information in a conveyance container when the target object is an object that is not identified as the object of the first type by the first recognition device.

### CROSS REFERENCE TO RELATED APPLICATIONS

This application is based upon and claims the benefit of priority from Japanese patent application No. 2022-039111, filed on Mar. 14, 2022, the disclosure of which is incorporated herein in its entirety by reference.

### BACKGROUND

The present disclosure relates to a conveyance system, a method for controlling the same, and a control program.

Japanese Unexamined Patent Application Publication No. 2018-103290 discloses a picking device including a robot that classifies an article in accordance with a request, in which the picking device includes: an inventory storage area having a mounting surface on which a number of articles are mounted; a visual sensor that detects a position or a position and a posture of each of the plurality of articles on the mounting surface; a robot having a hand that grasps the articles one by one based on the detected position or the position and the posture of each of the articles; and a conveyor unit that classifies the article grasped by robot. In the picking device, the visual sensor detects a type of each of the articles together with the position or the position and the posture of each of the articles, and operations of the robot are performed based on a result of the detection.

### SUMMARY

However, there is a problem that the device disclosed in Japanese Unexamined Patent Application Publication No. 2018-103290 cannot classify an article of type which cannot be detected by the visual sensor and hence this article has to be excluded from articles to be conveyed.

The present disclosure has been made in view of the aforementioned circumstances and an object thereof is to provide a conveyance system, a method for controlling the same, and a control program that enable not only an object that can be recognized by a recognition device but also an object that cannot be recognized by the recognition device to be classified and included in objects to be conveyed.

A first exemplary aspect is a conveyance system including: a first recognition device configured to identify whether or not a target object is an object of a first type; and a work robot configured to classify the target object as the object of the first type when the target object is identified as the object of the first type by the first recognition device and to classify the target object as an object of a type corresponding to position information in a conveyance container when the target object is an object that is not identified as the object of the first type by the first recognition device. In this conveyance system, it is possible to classify a target object recognized by the recognition device as an object of the recognized type, and it is also possible to classify a target object that is not recognized by the recognition device as an object of a type corresponding to position information in the conveyance container by disposing the target object that is not recognized by the recognition device at a predetermined position in the conveyance container. That is, this conveyance system enables not only an object that can be recognized by the recognition device but also an object that cannot be recognized by the recognition device to be classified and included in objects to be conveyed. Further, in this conveyance system, since it is not necessary to physically attach a marker (e.g., a sticker with a bar code or a QR code (registered trademark)) to an object that is not recognized by the recognition device, costs can be reduced.

When the target object is the object that is not identified as the object of the first type by the first recognition device, the work robot may classify the target object as an object of a type corresponding to a relative position of the target object with respect to a reference position in the conveyance container.

When the target object is the object that is not identified as the object of the first type by the first recognition device, the work robot may classify the target object as an object of a type corresponding to an area in the conveyance container where the target object is disposed among a plurality of divided areas in the conveyance container. In this case, the plurality of divided areas in the conveyance container may be divided by, for example, a partition.

The conveyance system may further include: a first pre-conveyance recognition device configured to identify, in a conveyance source of the target object that has not yet been conveyed to a conveyance destination where the work robot is installed, whether or not the target object is the object of the first type; a notification apparatus configured to notify that the target object is not the object of the first type when the target object is not identified as the object of the first type by the first pre-conveyance recognition device; and a conveyance apparatus configured to convey the target object from the conveyance source to the conveyance destination. By this configuration, when the target object is not identified as the object of the first type by the first pre-conveyance recognition device installed in the conveyance source, a notification that the target object is not the object of the first type is sent to a user (an administrator, a worker, etc.) of the system. Therefore, the user who has received the notification can attach a marker to the target object or dispose the target object at a predetermined position in the conveyance container, to thereby add instance information (information about a type of the target object) to the target object.

The conveyance system may further include: a first pre-conveyance recognition device configured to identify, in a conveyance source of the target object that has not yet been conveyed to a conveyance destination where the work robot is installed, whether or not the target object is the object of the first type; an instance information adding apparatus configured to dispose the target object at a predetermined position in the conveyance container when the target object is not identified as the object of the first type by the first pre-conveyance recognition device; and a conveyance apparatus configured to convey the target object from the conveyance source to the conveyance destination. By this configuration, when the target object is not identified as the object of the first type by the first pre-conveyance recognition device installed in the conveyance source, the instance information adding apparatus can dispose the target object at a predetermined position in the conveyance container, thereby adding instance information (information about classification) to the target object.

The conveyance system may further include a second recognition device configured to identify whether or not the target object is an object of a second type, in which the work robot may classify the target object as the object of the first type when the target object is identified as the object of the first type by the first recognition device, classify the target object as the object of the second type when the target object is identified as the object of the second type by the second recognition device, and classify the target object as the object of the type corresponding to the position information in the conveyance container when the target object is an object that is not identified as the object of the first type or the second type by the first and the second recognition devices.

The conveyance system may further include: a first pre-conveyance recognition device configured to identify, in a conveyance source of the target object that has not yet been conveyed to a conveyance destination where the work robot is installed, whether or not the target object is the object of the first type; a second pre-conveyance recognition device configured to identify, in the conveyance source, whether or not the target object is the object of the second type; a notification apparatus configured to notify that the target object is not the object of the first and the second types when the target object is not identified as the object of the first and the second types by the first and the second pre-conveyance recognition devices; and a conveyance apparatus configured to convey the target object from the conveyance source to the conveyance destination. By this configuration, when the target object is not identified as the object of the first and the second types by the first and the second pre-conveyance recognition devices installed in the conveyance source, a notification that the target object is not the object of the first and the second types is sent to a user (an administrator, a worker, etc.) of the system. Therefore, the user who has received the notification can attach a marker to the target object or dispose the target object at a predetermined position in the conveyance container, to thereby add instance information (information about a type of the target object) to the target object.

The conveyance system may further include: a first pre-conveyance recognition device configured to identify, in a conveyance source of the target object that has not yet been conveyed to a conveyance destination where the work robot is installed, whether or not the target object is the object of the first type; a second pre-conveyance recognition device configured to identify, in the conveyance source, whether or not the target object is the object of the second type; an instance information adding apparatus configured to dispose the target object at a predetermined position in the conveyance container when the target object is not identified as the object of the first and the second types by the first and the second pre-conveyance recognition devices; and a conveyance apparatus configured to convey the target object from the conveyance source to the conveyance destination. By this configuration, when the target object is not identified as the object of the first and the second types by the first and the second pre-conveyance recognition devices installed in the conveyance source, the instance information adding apparatus can dispose the target object at a predetermined position in the conveyance container, thereby adding instance information (information about a type of the target object) to the target object.

When the target object is identified as the object of the first type by the first recognition device, the work robot may classify the target object using a first operation planning method, while when the target object is classified as the object of the type corresponding to the position information in the conveyance container, the work robot may classify the target object using a second operation planning method that is different from the first operation planning method.

Another exemplary aspect is a method for controlling a conveyance system, the conveyance system including at least a first recognition device and a work robot, the method including: identifying whether or not a target object is an object of a first type by using the first recognition device; and by using the work robot, classifying the target object as the object of the first type when the target object is identified as the object of the first type by the first recognition device, and classifying the target object as an object of a type corresponding to position information in a conveyance container when the target object is an object that is not identified as the object of the first type by the first recognition device. In this method for controlling a conveyance system, it is possible to classify a target object recognized by the recognition device as an object of the recognized type, and it is also possible to classify a target object that is not recognized by the recognition device as an object of a type corresponding to position information in the conveyance container by disposing the target object that is not recognized by the recognition device at a predetermined position in the conveyance container. That is, this method for controlling a conveyance system enables not only an object that can be recognized by the recognition device but also an object that cannot be recognized by the recognition device to be classified and included in objects to be conveyed.

Another exemplary aspect is a control program for a conveyance system, the conveyance system including at least a first recognition device and a work robot, the control program causing a computer to: identify whether or not a target object is an object of a first type by using the first recognition device; and by using the work robot, classify the target object as the object of the first type when the target object is identified as the object of the first type by the first recognition device, and classify the target object as an object of a type corresponding to position information in a conveyance container when the target object is an object that is not identified as the object of the first type by the first recognition device. In this control program, it is possible to classify a target object recognized by the recognition device as an object of the recognized type, and it is also possible to classify a target object that is not recognized by the recognition device as an object of a type corresponding to position information in the conveyance container by disposing the target object that is not recognized by the recognition device at a predetermined position in the conveyance container. That is, this control program enables not only an object that can be recognized by the recognition device but also an object that cannot be recognized by the recognition device to be classified and included in objects to be conveyed.

According to the present disclosure, it is possible to provide a conveyance system, a method for controlling the same, and a control program that enable not only an object that can be recognized by a recognition device but also an object that cannot be recognized by the recognition device to be classified and included in objects to be conveyed.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing an example of a conveyance system according to a first embodiment;

FIG. 2 is a diagram for explaining an example of a method for identifying a target object disposed in a conveyance container used in the conveyance system according to the first embodiment;

FIG. 3 is a diagram for explaining an example of the method for identifying a target object disposed in a conveyance container used in the conveyance system according to the first embodiment;

FIG. 4 is a diagram for explaining another example of a method for identifying a target object disposed in a conveyance container used in the conveyance system according to the first embodiment;

FIG. 5 is a diagram for explaining another example of the method for identifying a target object disposed in a conveyance container used in the conveyance system according to the first embodiment;

FIG. 6 is a flowchart showing operations of the conveyance system according to the first embodiment;

FIG. 7 is a schematic diagram showing a modified example of the conveyance system according to the first embodiment;

FIG. 8 is a schematic diagram showing a conveyance system according to a second embodiment; and

FIG. 9 is a schematic diagram showing a conveyance system according to a third embodiment.

### DESCRIPTION OF EMBODIMENTS

The present disclosure will be described hereinafter through embodiments of the present disclosure. However, the following embodiments are not intended to limit the scope of the disclosure according to the claims. Further, all the components/structures described in the embodiments are not necessarily indispensable as means for solving the problem. For the clarification of the description, the following descriptions and the drawings are partially omitted and simplified as appropriate. The same elements are denoted by the same reference numerals or symbols throughout the drawings, and redundant descriptions are omitted as necessary.

### First Embodiment

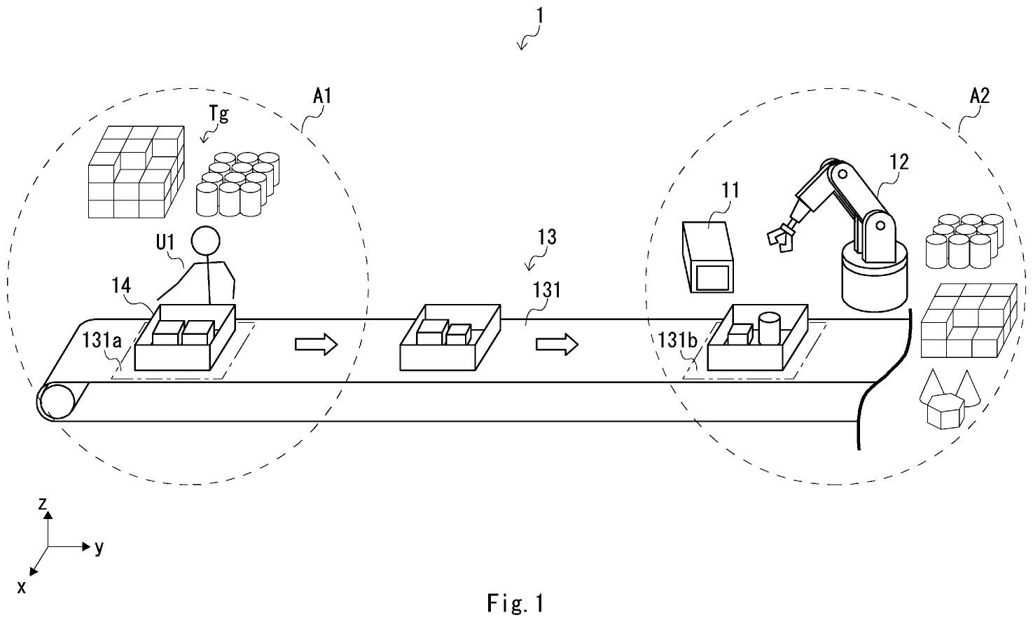

FIG. 1 is a schematic diagram showing an example of a conveyance system 1 according to a first embodiment. In the conveyance system 1, it is possible to classify a target object recognized by a recognition device as an object of the recognized type, and it is also possible to classify a target object that is not recognized by the recognition device as an object of a type corresponding to position information in the conveyance container by disposing the target object that is not recognized by the recognition device at a predetermined position in the conveyance container. That is, this conveyance system enables not only an object that can be recognized by the recognition device but also an object that cannot be recognized by the recognition device to be classified and included in objects to be conveyed. The details of the above configuration will be described below.

As shown in FIG. 1, the conveyance system 1, which conveys a variety of target objects Tg from a conveyance source A1 to a conveyance destination A2, includes at least a recognition device 11, a work robot 12, and a conveyance apparatus 13.

The conveyance apparatus 13 is a belt conveyor that conveys the target objects Tg by rotating a belt 131. A worker U1 (or a work robot that is not shown) places a conveyance container 14 in which certain target objects Tg are stored in a mounting area 131a of the belt 131 located in the conveyance source A1. Then, the conveyance apparatus 13 rotates the belt 131, thereby conveying the conveyance container 14 in which the certain target objects Tg are stored, which is placed in the mounting area 131a of the belt 131, to a mounting area 131b of the belt 131 located in the conveyance destination A2.

The recognition device 11 is installed in the conveyance destination A2. The recognition device 11 identifies whether or not the target object Tg conveyed to the conveyance destination A2 by the conveyance apparatus 13 is an object of the type learned in advance by the recognition device 11. In this embodiment, a description will be given of an example of a case in which the recognition device 11 identifies whether or not the target object Tg conveyed to the conveyance destination A2 by the conveyance apparatus 13 is an object of a first type or a second type learned in advance by the recognition device 11.

The work robot 12 is installed in the conveyance destination A2. The work robot 12 classifies the target object Tg conveyed to the conveyance destination A2 by the conveyance apparatus 13 as the object of the first type when the target object Tg is identified as the object of the first type by the recognition device 11. Further, the work robot 12 classifies the target object Tg conveyed to the conveyance destination A2 by the conveyance apparatus 13 as the object of the second type when the target object Tg is identified as the object of the second type by the recognition device 11.

At this time, the work robot 12 performs classification using a first operation planning method. The classification using the first operation planning method refers to classification performed by the work robot 12 using a grasping method dedicated to the target object Tg (the target object Tg of the first and the second types in this example) of specific types. For example, in the recognition device 11, training (learning) using training data regarding the target object Tg of each of the first and the second types is conducted in advance. By doing the above, the recognition device 11 can identify the target object Tg of each of the first and the second types, and also can specify the position, the posture, and the like of the target object Tg of each of the first and the second types. Further, the work robot 12 grasps the target object Tg of the first type or the second type recognized by the recognition device 11 in which the training has been performed based on the position and the posture of the target object Tg, and classifies this target object Tg.

In contrast to the above, instance information is added by, for example, the worker U1 (or a work robot that is not shown) in the conveyance source A1 to the target object Tg of a type that has not been learned in advance by the recognition device 11 (in other words, the target object Tg of a type that cannot be identified by the recognition device 11). The instance information is information indicating a type of the target object Tg. Specifically, in the conveyance source A1, for example, the worker U1 attaches a marker (e.g., a sticker with a bar code or a QR code) to the target object Tg of a type that has not been learned in advance by the recognition device 11, or disposes it at a predetermined position in the conveyance container 14. By doing so, in the conveyance destination A2, the work robot 12 can classify the target object Tg to which the marker has been attached as an object of the type described on the marker, or can classify the target object Tg disposed at a predetermined position in the conveyance container 14 as an object of the type corresponding to position information in the conveyance container 14. Note that, regarding a way of adding instance information, the cost reduction can be achieved by disposing the target object Tg at a predetermined position in the conveyance container 14 rather than physically attaching a marker to the target object Tg.

At this time, the work robot 12 performs classification using a second operation planning method different from the first operation planning method. The classification using the second operation planning method refers to classification performed by the work robot 12 using a method for grasping the target object Tg (the target object Tg of a type other than the first and the second types in this example) of types that are not limited to specific types. For example, in the recognition device 11, training using training data regarding a plurality of target objects Tg of types that are not limited to specific types is conducted in advance. By doing the above, the recognition device 11 can specify the position and the posture of the target object Tg of the type that cannot be identified. Further, the work robot 12 grasps the target object Tg of the type that cannot be identified by the recognition device 11 in which the training has been performed based on the position and the posture of the target object Tg, and classifies this target object Tg as an object of a type corresponding to position information in the conveyance container 14.

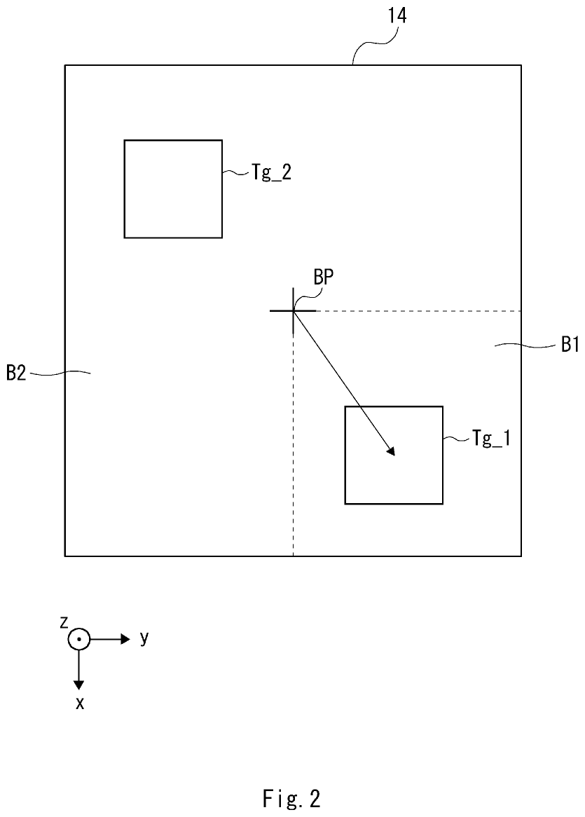

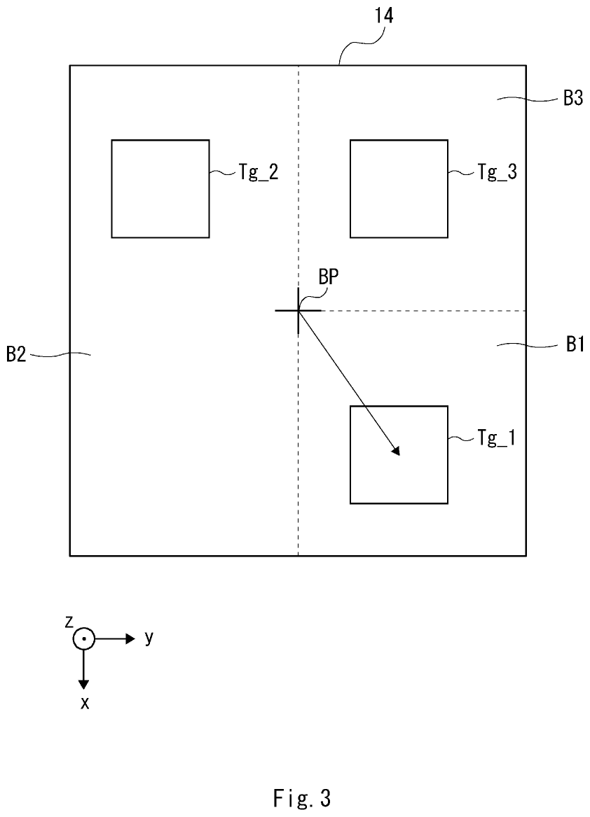

Each of FIGS. 2 and 3 is a diagram for explaining an example of a method for identifying the target object Tg disposed in the conveyance container 14. For example, when the target object Tg is an object that is not identified as the object of the first type or the second type by the recognition device 11 (i.e., when the target object Tg is not identified as the object of the first type or the second type by the recognition device 11), the work robot 12 classifies the target object Tg as an object of a type corresponding to a relative position of the target object Tg with respect to a reference position BP in the conveyance container 14.

First, in the example of FIG. 2, regarding areas B1 and B2 in the conveyance container 14, the target object Tg disposed in the area B1 on the positive side in the x-axis and the y-axis directions with respect to the reference position BP is identified as an object of a type other than the first and the second types. Therefore, regarding target objects Tg_1 and Tg_2 which are the target objects Tg, the work robot 12 classifies the object Tg_1 disposed in the area B1 as an object of a type other than the first and the second types.

Further, in the example of FIG. 3, regarding the areas B1 to B3 in the conveyance container 14, the target object Tg disposed in the area B1 is identified as an object of a third type other than the first and the second types, and the target object Tg disposed in the area B3 on the negative side in the x-axis direction and the positive side in the y-axis direction with respect to the reference position BP is identified as an object of a fourth type other than the first and the second types. Therefore, regarding the target objects Tg_1 to Tg_3 which are the target objects Tg, the work robot 12 classifies the object Tg_1 disposed in the area B1 as an object of the third type, and classifies the object Tg_3 disposed in the area B3 as an object of the fourth type.

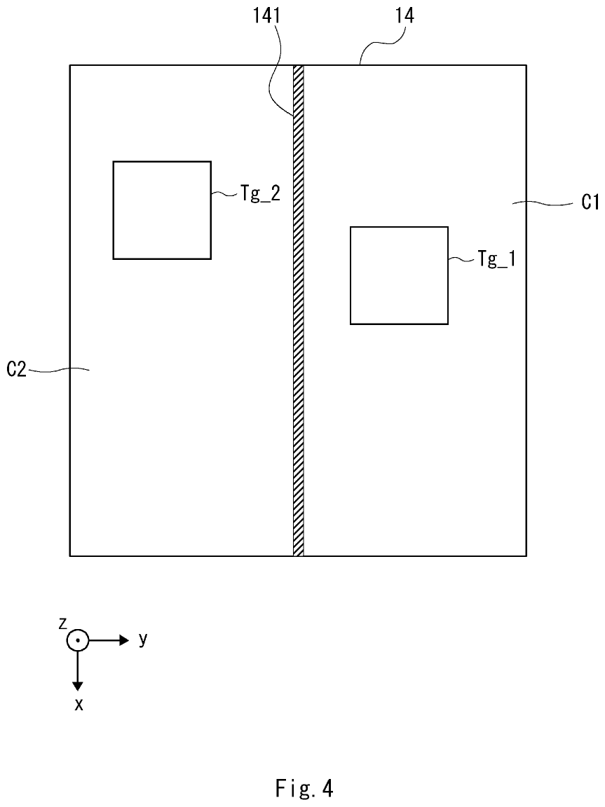

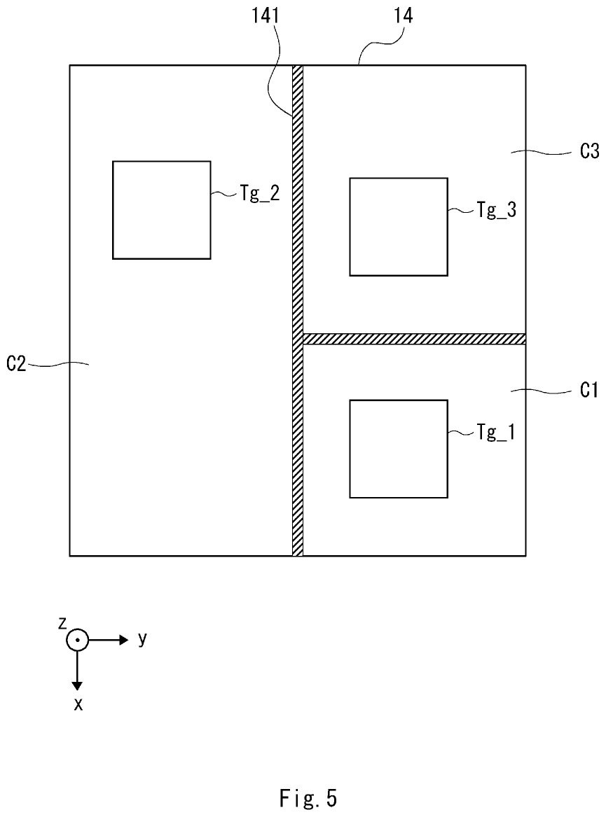

Each of FIGS. 4 and 5 is a diagram for explaining another example of a method for identifying the target object Tg disposed in the conveyance container 14. For example, when the target object Tg is an object that is not identified as the object of the first type or the second type by the recognition device 11 (i.e., when the target object Tg is not identified as the object of the first type or the second type by the recognition device 11), the work robot 12 classifies the target object Tg as an object of a type corresponding to an area in the conveyance container 14 where the target object Tg is disposed among a plurality of divided areas in the conveyance container 14.

First, in the example of FIG. 4, regarding areas C1 and C2 divided by a partition 141, the target object Tg disposed in the area C1 is identified as an object of a type other than the first and the second types. Therefore, regarding the target objects Tg_1 and Tg_2 which are the target objects Tg, the work robot 12 classifies the object Tg_1 disposed in the area C1 as an object of a type other than the first and the second types.

Further, in the example of FIG. 5, regarding the areas C1 to C3 divided by the partitions 141, the target object Tg disposed in the area C1 is identified as an object of the third type other than the first and the second types, and the target object Tg disposed in the area C3 is identified as an object of the fourth type other than the first and the second types. Therefore, regarding the target objects Tg_1 to Tg_3 which are the target objects Tg, the work robot 12 classifies the object Tg_1 disposed in the area C1 as an object of the third type, and classifies the object Tg_3 disposed in the area C3 as an object of the fourth type.

### (Operations of the Conveyance System 1)

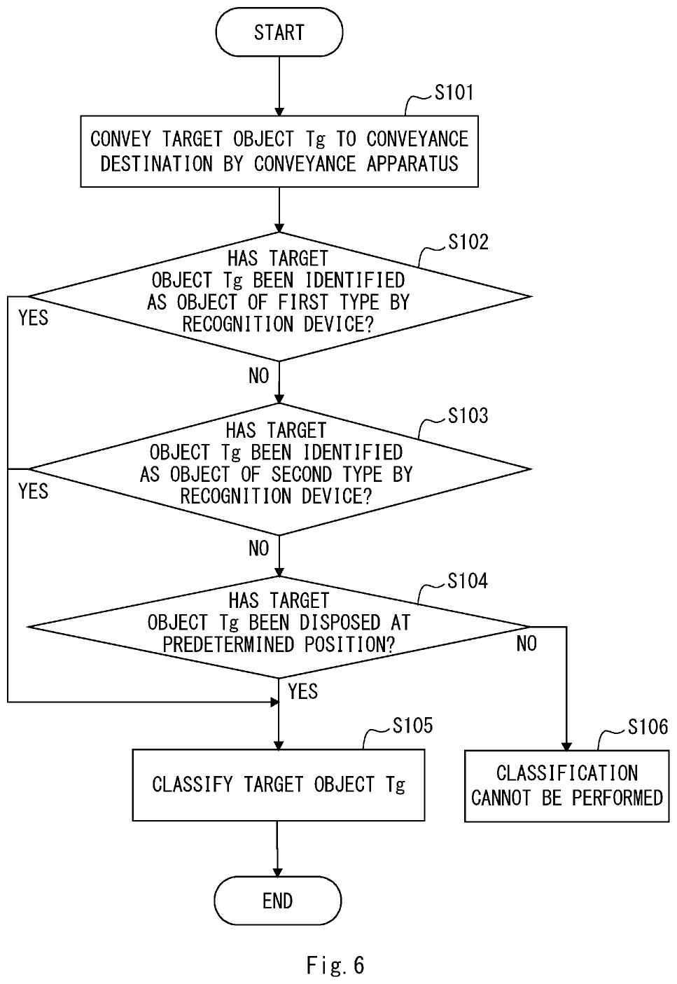

Next, operations of the conveyance system 1 will be described with reference to FIG. 6.

FIG. 6 is a flowchart showing the operations of the conveyance system 1.

First, in the conveyance system 1, the target object Tg is conveyed from the conveyance source A1 to the conveyance destination A2 by the conveyance apparatus 13 (Step S101). Note that the target object Tg is stored in the conveyance container 14 and then conveyed by the conveyance apparatus 13.

After that, in the conveyance destination A2, the recognition device 11 identifies whether or not the target object Tg is an object of the first type (Step S102).

For example, when the target object Tg is identified as the object of the first type by the recognition device 11 (YES in Step S102), the work robot 12 classifies the target object Tg as the object of the first type (Step S105). On the other hand, when the target object Tg is not identified as the object of the first type by the recognition device 11 (NO in Step S102), the recognition device 11 then identifies whether or not the target object Tg is an object of the second type (Step S103).

For example, when the target object Tg is identified as the object of the second type by the recognition device 11 (YES in Step S103), the work robot 12 classifies the target object Tg as the object of the second type (Step S105). On the other hand, when the target object Tg is not identified as the object of the second type by the recognition device 11 (NO in Step S103), that is, when the target object Tg is not identified as either the object of the first type or the second type by the recognition device 11, the work robot 12 classifies the target object Tg disposed at a predetermined position in the conveyance container 14 as an object of a type corresponding to position information in the conveyance container 14 (YES in Step S104->Step S105). Note that when the target object Tg is not disposed at a predetermined position in the conveyance container 14 (NO in Step S104), classification is not performed by the work robot 12 (Step S106).

As described above, in the conveyance system 1 according to this embodiment, it is possible to classify a target object Tg recognized by the recognition device 11 as an object of the recognized type, and it is also possible to classify a target object Tg that is not recognized by the recognition device 11 as an object of a type corresponding to position information in the conveyance container 14 by disposing the target object Tg that is not recognized by the recognition device 11 at a predetermined position in the conveyance container 14. That is, the conveyance system 1 according to this embodiment enables not only an object that can be recognized by the recognition device 11 but also an object that cannot be recognized by the recognition device 11 to be classified and included in objects to be conveyed.

Note that, in this embodiment, a description has been given of an example of a case in which the work robot 12 classifies the target object Tg as an object of a type corresponding to position information in the conveyance container 14 when the target object Tg is not identified as the object of the first type or the second type by the recognition device 11. However, the present disclosure is not limited thereto. For example, when it is obvious that the target object Tg of a type other than the first and the second types is disposed at a predetermined position in the conveyance container 14, the work robot 12 may classify this target object Tg as an object of a type corresponding to position information in the conveyance container 14 without using the recognition device 11.

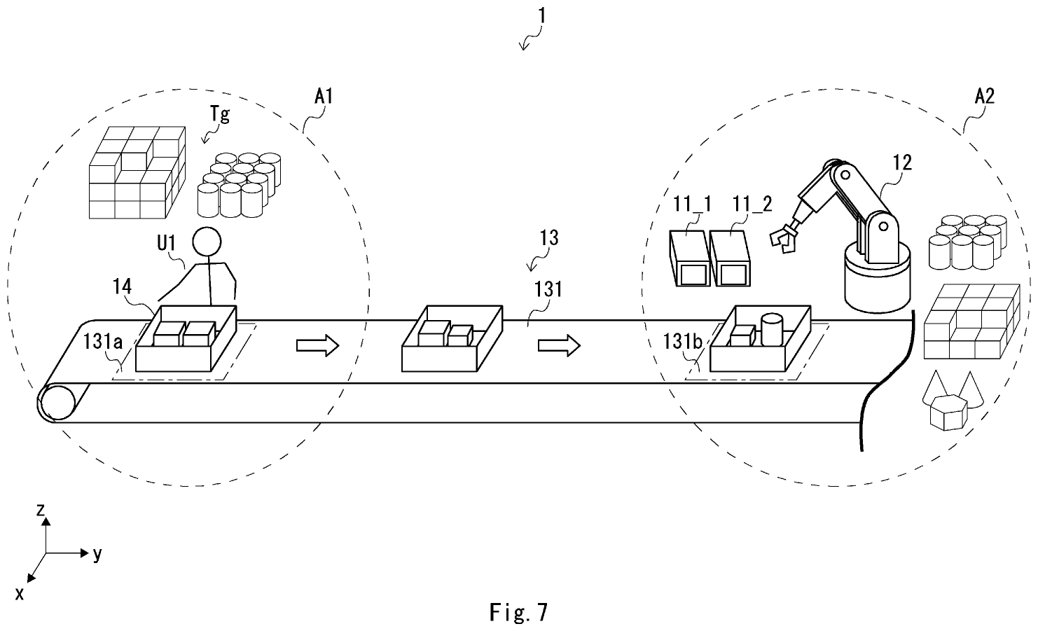

Further, in this embodiment, a description has been given of an example of a case in which the recognition device 11 identifies whether or not the target object Tg is the object of the first or the second type. However, the present disclosure is not limited thereto. The recognition device 11 may be configured to identify only whether or not the object Tg is the object of the first type, or it may be configured to identify which of three or more types of objects the target object Tg is. Further, as shown in a modified example in FIG. 7, instead of the recognition device 11 that identifies whether or not the target object Tg is the object of the first or the second type, a recognition device 11_1 that identifies whether or not the target object Tg is the object of the first type and a recognition device 11_2 that identifies whether or not the target object Tg is the object of the second type may be provided independently of each other.

### Second Embodiment

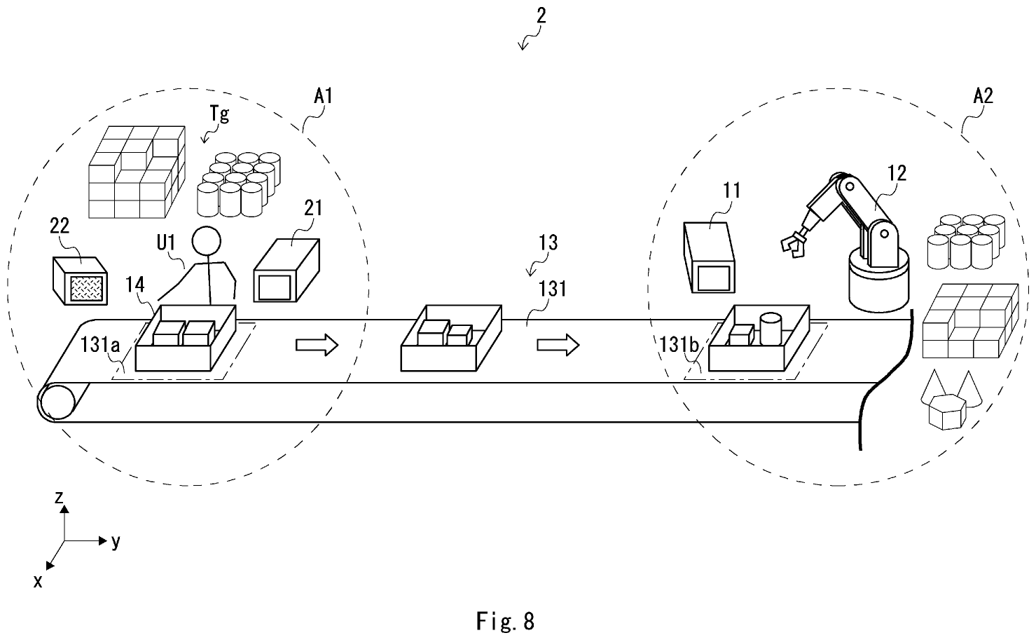

FIG. 8 is a schematic diagram showing a conveyance system 2 according to a second embodiment.

As compared to the conveyance system 1, the conveyance system 2 further includes a pre-conveyance recognition device 21 and a notification apparatus 22 in the conveyance source A1. The configurations of the conveyance system 2 other than the above one are similar to those of the conveyance system 1.

The pre-conveyance recognition device 21 has a function similar to that of the recognition device 11, and identifies whether or not the target object Tg which has not yet been conveyed is an object of the type learned in advance by the pre-conveyance recognition device 21. In this embodiment, like the recognition device 11, the pre-conveyance recognition device 21 is configured to identify whether or not the target object Tg is an object of the first or the second type.

When the target object Tg is not identified as either the object of the first type or the second type by the pre-conveyance recognition device 21, the notification apparatus 22 notifies that the target object Tg is neither the object of the first type nor the object of the second type. In other words, the notification apparatus 22 notifies that the target object Tg is an object that is not recognized by the pre-conveyance recognition device 21 (the recognition device 11) when the target object Tg is not identified as either the object of the first type or the second type by the pre-conveyance recognition device 21.

By the above configuration, a user (an administrator, a worker, etc.) who has received the notification provided by the notification apparatus 22 can attach a marker to the target object Tg or dispose the target object Tg at a predetermined position in the conveyance container 14, to thereby add instance information (information about a type of the target object Tg) to the target object Tg. As a result, in the conveyance destination A2, the work robot 12 can quickly classify the target object Tg that is not recognized by the recognition device 11 as, for example, an object of a type corresponding to position information in the conveyance container 14.

Further, in this embodiment, a description has been given of an example of a case in which the pre-conveyance recognition device 21 identifies whether or not the target object Tg is the object of the first or the second type. However, the present disclosure is not limited thereto. The pre-conveyance recognition device 21 may be configured to identify only whether or not the object Tg is the object of the first type, or it may be configured to identify which of three or more types of objects the target object Tg is. Further, instead of the pre-conveyance recognition device 21 that identifies whether or not the target object Tg is the object of the first or the second type, a pre-conveyance recognition device 21 that identifies whether or not the target object Tg is the object of the first type and a pre-conveyance recognition device 21 that identifies whether or not the target object Tg is the object of the second type may be provided independently of each other.

### Third Embodiment

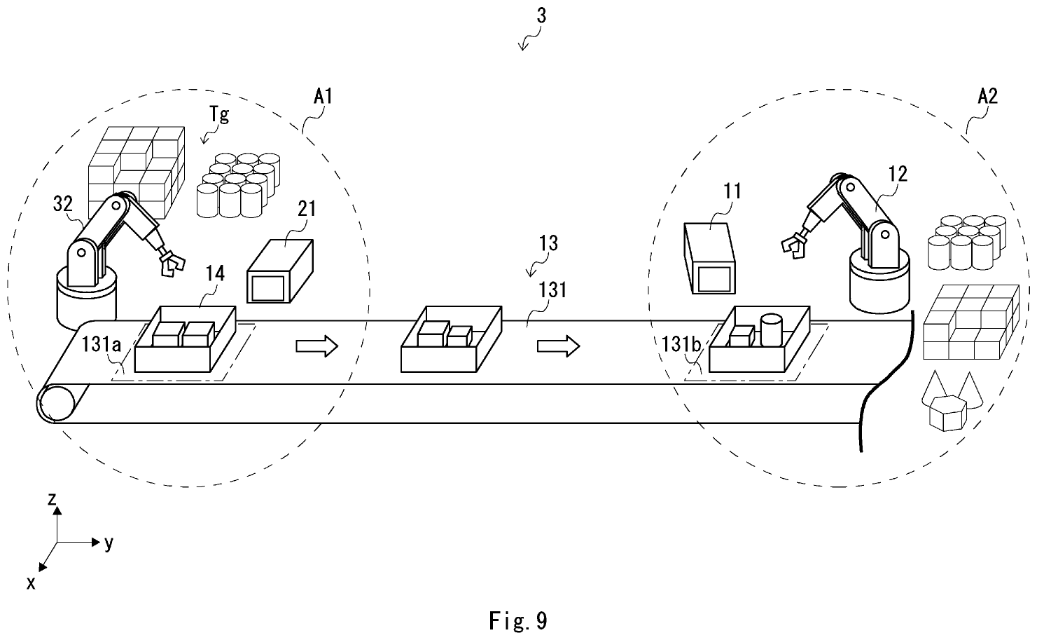

FIG. 9 is a schematic diagram showing a conveyance system 3 according to a third embodiment.

As compared to the conveyance system 2, the conveyance system 3 includes, in the conveyance source A1, a work robot (an instance information adding apparatus) 32 instead of the notification apparatus 22. The configurations of the conveyance system 3 other than the above one are similar to those of the conveyance system 2.

When the target object Tg is not identified as either an object of the first type or the second type by the pre-conveyance recognition device 21, the work robot 32 disposes the target object Tg at a predetermined position in the conveyance container 14, thereby adding instance information (information about a type of the target object Tg) to the target object Tg. As a result, in the conveyance destination A2, the work robot 12 can quickly classify the target object Tg that is not recognized by the recognition device 11 as an object of a type corresponding to position information in the conveyance container 14.

Note that the present disclosure is not limited to the above-described embodiments and may be changed as appropriate without departing from the scope of the present disclosure.

Further, in the present disclosure, it is possible to implement all or part of control processing performed in the conveyance system by causing a Central Processing Unit (CPU) to execute a computer program.

The above-described program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A conveyance system comprising:
a first recognition device configured to identify whether or not a target object is an object of a first type; and
a work robot configured to classify the target object as the object of the first type when the target object is identified as the object of the first type by the first recognition device and to classify the target object as an object of a type corresponding to position information in a conveyance container when the target object is an object that is not identified as the object of the first type by the first recognition device.

2. The conveyance system according to claim 1, wherein when the target object is the object that is not identified as the object of the first type by the first recognition device, the work robot classifies the target object as an object of a type corresponding to a relative position of the target object with respect to a reference position in the conveyance container.

3. The conveyance system according to claim 1, wherein when the target object is the object that is not identified as the object of the first type by the first recognition device, the work robot classifies the target object as an object of a type corresponding to an area in the conveyance container where the target object is disposed among a plurality of divided areas in the conveyance container.

4. The conveyance system according to claim 3, wherein the plurality of divided areas in the conveyance container are divided by a partition.

5. The conveyance system according to claim 1, further comprising:
a first pre-conveyance recognition device configured to identify, in a conveyance source of the target object that has not yet been conveyed to a conveyance destination where the work robot is installed, whether or not the target object is the object of the first type;
a notification apparatus configured to notify that the target object is not the object of the first type when the target object is not identified as the object of the first type by the first pre-conveyance recognition device; and
a conveyance apparatus configured to convey the target object from the conveyance source to the conveyance destination.

6. The conveyance system according to claim 1, further comprising:
a first pre-conveyance recognition device configured to identify, in a conveyance source of the target object that has not yet been conveyed to a conveyance destination where the work robot is installed, whether or not the target object is the object of the first type;
an instance information adding apparatus configured to dispose the target object at a predetermined position in the conveyance container when the target object is not identified as the object of the first type by the first pre-conveyance recognition device; and
a conveyance apparatus configured to convey the target object from the conveyance source to the conveyance destination.

7. The conveyance system according to claim 1, further comprising a second recognition device configured to identify whether or not the target object is an object of a second type,
wherein the work robot classifies the target object as the object of the first type when the target object is identified as the object of the first type by the first recognition device, classifies the target object as the object of the second type when the target object is identified as the object of the second type by the second recognition device, and classifies the target object as the object of the type corresponding to the position information in the conveyance container when the target object is an object that is not identified as the object of the first type or the second type by the first and the second recognition devices.

8. The conveyance system according to claim 7, further comprising:
a first pre-conveyance recognition device configured to identify, in a conveyance source of the target object that has not yet been conveyed to a conveyance destination where the work robot is installed, whether or not the target object is the object of the first type;
a second pre-conveyance recognition device configured to identify, in the conveyance source, whether or not the target object is the object of the second type;
a notification apparatus configured to notify that the target object is not the object of the first and the second types when the target object is not identified as the object of the first and the second types by the first and the second pre-conveyance recognition devices; and
a conveyance apparatus configured to convey the target object from the conveyance source to the conveyance destination.

9. The conveyance system according to claim 7, further comprising:
a first pre-conveyance recognition device configured to identify, in a conveyance source of the target object that has not yet been conveyed to a conveyance destination where the work robot is installed, whether or not the target object is the object of the first type;
a second pre-conveyance recognition device configured to identify, in the conveyance source, whether or not the target object is the object of the second type;
an instance information adding apparatus configured to dispose the target object at a predetermined position in the conveyance container when the target object is not identified as the object of the first and the second types by the first and the second pre-conveyance recognition devices; and
a conveyance apparatus configured to convey the target object from the conveyance source to the conveyance destination.

10. The conveyance system according to claim 1, wherein when the target object is identified as the object of the first type by the first recognition device, the work robot classifies the target object using a first operation planning method, while when the target object is classified as the object of the type corresponding to the position information in the conveyance container, the work robot classifies the target object using a second operation planning method that is different from the first operation planning method.

11. A method for controlling a conveyance system, the conveyance system comprising at least a first recognition device and a work robot, the method comprising:
identifying whether or not a target object is an object of a first type by using the first recognition device; and
by using the work robot, classifying the target object as the object of the first type when the target object is identified as the object of the first type by the first recognition device, and classifying the target object as an object of a type corresponding to position information in a conveyance container when the target object is an object that is not identified as the object of the first type by the first recognition device.

12. A non-transitory computer readable medium storing a control program for a conveyance system, the conveyance system comprising at least a first recognition device and a work robot, the control program causing a computer to:
identify whether or not a target object is an object of a first type by using the first recognition device; and
by using the work robot, classify the target object as the object of the first type when the target object is identified as the object of the first type by the first recognition device, and classify the target object as an object of a type corresponding to position information in a conveyance container when the target object is an object that is not identified as the object of the first type by the first recognition device.
